(19) United States
(12) Patent Application Publication
(10) Pub. No.: US 2013/0153506 A1
(43) Pub. Date: Jun. 20, 2013

(54) METHOD TO IMPROVE CLARIFICATION PERFORMANCE IN WASTEWATER TREATMENT APPLICATIONS

(71) Applicants: Prasad Duggirala, Naperville, IL (US); Weiguo Cheng, Naperville, IL (US)

(72) Inventors: Prasad Duggirala, Naperville, IL (US); Weiguo Cheng, Naperville, IL (US)

(21) Appl. No.: 13/327,854

(22) Filed: Dec. 16, 2011

(51) Int. Cl. C02F 1/28; C02F 1/52

(52) U.S. Cl. 210/665; 210/660

(57) ABSTRACT

Disclosed is a cost effective method of clarifying wastewater. The method comprises the steps of providing wastewater and adding a substance to the wastewater. The substance comprises a porous particulate material. The porous particulate material may be perlite, and the substance may additionally comprise a coagulant.

### FIELD OF THE INVENTION

The present invention is related to the treatment of wastewater. More particularly, the present invention is related to a cost effective method of clarifying wastewater by adding a substance comprising a porous particulate material to the wastewater, where the substance may additionally comprise a coagulant.

### BACKGROUND

Wastewater clarification is the process of removing various contaminants such as suspended solids, oil, and turbidity in a primary wastewater treatment system. This process is generally carried out either in clarifiers (via settling) or dissolved air flotation (“DAF”) through the process of coagulation and flocculation. These processes, usually performed in sequence, are a combination of physical and chemical procedures. Chemicals are mixed with wastewater to promote the aggregation of the suspended solids into particles large enough to settle or float.

Earlier work has been performed using perlite as a filtration aid and in adsorption of oil in water. For example, a recent adsorption isotherm study showed that expended perlite was able to adsorb crude oil from the mixture of seawater and crude oil. (“Equilibrium sorption of crude oil by expanded perlite using different adsorption isotherms at 298.15 k” A. Alihosseini; V. Taghikhani; A. A. Safeknrdi; D. Bastani Int. Environ. Sci. Tech., 7 (3), 591-98. Summer 2010). Another earlier study showed that expanded perlite was able to adsorb emulsified oil from water (“Dispersion and Sorption of Oil Spills by Emulsifier-Modified Expanded Perilte” by M. Roulia, K. Chassapis, Ch. Fotinopoulos, Th, Savvidis, and D. Katakis, Spill Science & Technology Bulletin, Vol. B, Nos. 5-6, pp. 425-31,2003.

Accordingly, there is a need for a more cost effective method of treating wastewater. Desirably, the method will provide a more environmentally friendly alternative to those treating wastewater. More desirably, the method will he more effective in clarifying wastewater even though cheaper ingredients are used.

### SUMMARY OF THE INVENTION

The invention is directed toward a method of clarifying wastewater. The method comprises the steps of providing wastewater and adding a substance to the wastewater. The substance comprises a porous particulate material. The porous particulate material may be perlite, and the substance may additionally comprise a coagulant.

These and other features and advantages of the present invention will he apparent from the following detailed description, in conjunction with the appended claims.

### BRIEF DESCRIPTION OF THE SEVERAL VIEWS OF THE DRAWINGS

The benefits and advantages of the present invention will become more readily apparent to those of ordinary skill in the relevant art after reviewing the following detailed. description and accompanying drawings, wherein:

FIG. 1 is graph illustrating the positive effect of untreated perlite on clarification of wastewater of an oil refinery;

FIG. 2 is a graph illustrating the positive effects of two types of perlite on clarification of wastewater from an oil refinery; and

FIG. 3 is a graph illustrating the positive effects of perlite on clarification of wastewater from an oil refinery, including one experiment that tested a substance comprising perlite and a coagulant pre-mixed prior to the addition of the substance to the wastewater.

### DETAILED DESCRIPTION OF THE INVENTION/PREFERRED EMBODIMENT

While the present invention is susceptible of embodiment in various forms, there is shown in the drawings and will hereinafter be described a presently preferred embodiment with the understanding that the present disclosure is to be considered an exemplification of the invention and is not intended to limit the invention to the specific embodiment illustrated.

It should be further understood that the title of this section of this specification, namely, “Detailed Description of the Invention,” relates to a requirement of the United States Patent Office, and does not imply, nor should be inferred to limit the subject matter disclosed herein.

As it relates to this patent, the term “porous particulate material” means a material with similar or greater porosity as that of raw perlite or expanded perlite, and having a particle size that is similar to or smaller than expanded perlite, with each described below.

The invention particularly relates to compositions and methods for removing oil and other contaminants from wastewater. The composition comprises a fine grained, porous particulate material, such as expanded perlite which may be coated with an oleophilic/hydrophobic layer. Perlite is a glassy volcanic rock of rhyolitic composition usually containing 2-6% water. Raw perlite is a relatively porous material (porosity 45-55%) and, when heated rapidly at 700-1200° C., it expands, increasing 8-15 times its original volume, Expanded perlite has a characteristic structure composed of tiny irregular shreds randomly placed, and to a lesser extent tiny bubbles. These properties give the material: (a) excellent insulation properties (thermal conductivity 0.05 W/mK at a loose weight of 40 kg/m³); (b) lower density than water, which means that it can float in water; (c) high porosity (>90%) which increases its absorption capacity and then the density of the floc for rapid settling. Moreover perlite shows thermal and chemical inertness and is friendly to the environment.

In an embodiment, a substance comprising a porous particulate material is added to the wastewater. The porous particulate material may be coated with an oleophilic/hydrophobic layer. The porous particulate material may he perlite. A coagulant may additionally be added to the wastewater before, after, or at the same time as the addition of the substance. The perlite may be raw perlite, expanded perlite, or a combination of the two. The substance may consist of only perlite, or essentially only perlite. A flocculant may be added to the wastewater in addition to the substance or the substance-coagulant mix. The flocculant may be added subsequent to the adding of the substance.

In a presently preferred embodiment, the substance is comprised of a porous particulate material and a coagulant, with the porous particulate material consisting of perlite, and the perlite comprising expanded perlite.

In an embodiment, the coagulant comprises polydiallyldimethylammonium chloride, known by those of skill in the art as “polyDADMAC.”

In an embodiment, the substance comprising the porous particulate material is added prior to or into a unit operation of a wastewater treatment plant. The unit operation may be an initial unit operation of the wastewater treatment plant. The unit operation may be a DAP unit operation or a ballasted settling unit operation. The addition of a substance comprising a porous particulate material earn be effectively utilized in either type of unit operation.

For this invention, the porous particulate material seems to work as au initiator in the wastewater clarification process, enhancing the effect of the coagulant. The enhancement may be due to the porous particulate material's positive effect on both settling and absorption. The enhancement of the coagulant provides a recognized synergy that is illustrated in the Examples below.

### EXAMPLES

Unexpectedly good results were achieved in the following Examples, which are presented to allow one skilled in the art to better understand the invention. However, the claims should not be construed as to incorporated limitations presented in the Examples unless expressly incorporated into the language of the allowed claims. For the following Examples, the perlite used was crushed expanded perlite (filter grade) obtained from Silbrico Corporation, 6300 River Road, Hodgkins, Ill. 60525-5189.

### Example 1

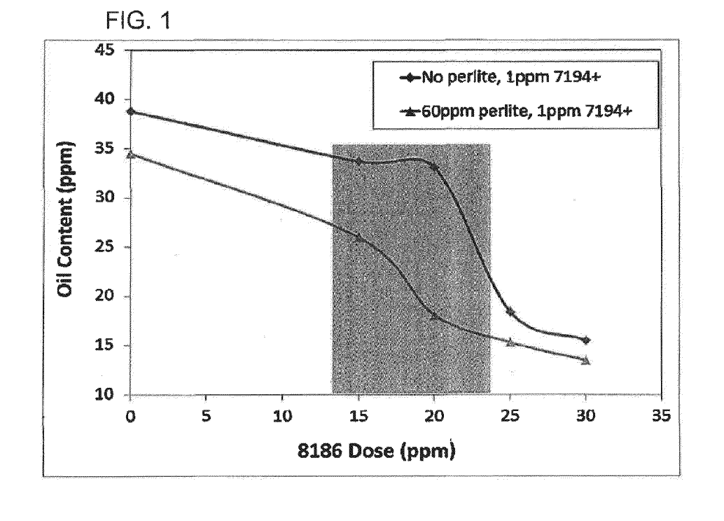

We have investigated the concept of using expanded. perlite to remove oil content from refinery wastewater. The first experiment was done using standard jar test. Wastewater was obtained, from a Louisiana. oil refinery's DAF influent, The results were shown in FIG. 1. The oil content of untreated wastewater was around 40 ppm. The refinery's current treatment program is the combination of Nalco 8186 coagulant and Nalco 7194 Plus flocculant, each available from Nalco Company, 1601, West Diehl Road, Naperville, Ill. 60563. With 30 ppm 8186 and 1 ppm 7194, the oil content could be reduced to around 15 ppm. To the current program, 60 ppm expanded perlite was added into the wastewater and mixed thoroughly liar five minutes before the addition of the coagulant. The addition of perlite helped the removal of oil content greatly when coagulant dose was at 15 ppm and 20 ppm. However, the effect was much less when coagulant dose reached optimum, i.e., 30 ppm. Nalco 8186 coagulant is comprised of polyDADMAC.

### Example 2

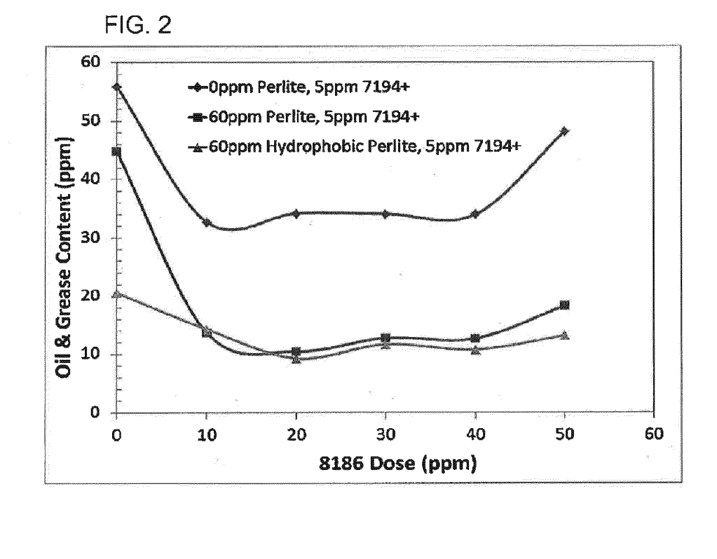

In order to enhance the oil removal through adsorption, perlite was treated using silicon oil to make the surface more hydrophobic. Because of its hydrophobicity, treated perlite is hard to mix into wastewater and requires vigorous mixing. Once again, a standard jar test was performed on a wastewater sample from the same Louisiana refinery's influent, and the effect of untreated perlite and hydrophobic perlite was compared using the same treatment program outlined in Example 1. The results are shown in FIG. 2.

In the absence of coagulant, the oil removal by untreated perlite was very limited, but the combination of hydrophobic perlite and flocculant removed a significant amount of oil content, indicating the oil adsorption capability of hydrophobic perlite. The performance difference between untreated perlite and hydrophobic perlite became small with the addition of the coagulant, probably because the remaining oil content in the waste water was small, i.e. around 12 ppm.

### Example 3

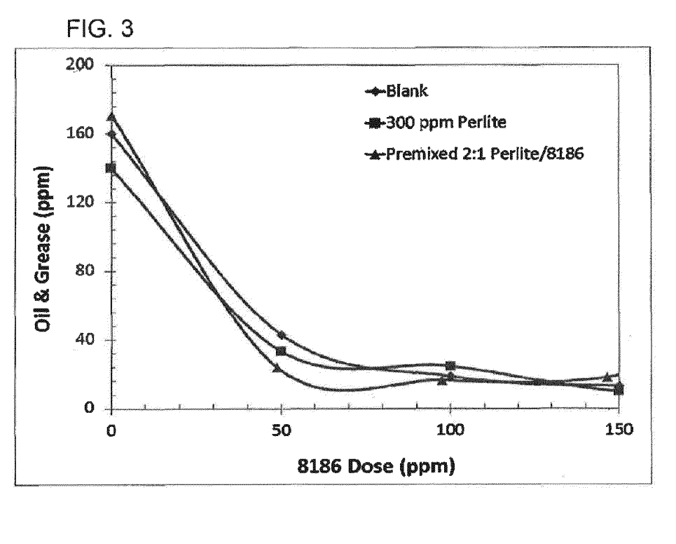

The effect of premixing perlite with coagulant was investigated in this example. The wastewater sample was obtained from an Illinois refinery. The results are shown in FIG. 3.

Premixing perlite, with coagulant removed significantly more oil than adding perlite and coagulant separately at a low coagulant dose, For example, a premixed coagulant-perlite blend having 48.8 ppm 8186 and 97.6 ppm perlite decreased the oil content in the sample to 23.9 ppm, while 100 ppm 8186 decreased the sample's oil content to 18.6 ppm. By premixing perlite with coagulant, a significant amount of expensive coagulant can be replaced by inexpensive perlite while maintaining quality of treated water, thereby reducing total wastewater treatment cost.

All patents referred to herein, are hereby incorporated herein by reference, whether or not specifically done so within the text of this disclosure.

In the present disclosure, the words “a” or “an” are to be taken to include both the singular and the plural. Conversely, any reference to plural items shall, where appropriate, include the singular.

From the foregoing it will be observed that numerous modifications and variations can be effectuated without departing from the true spirit and scope of the novel concepts of the present invention. It is to be understood that no limitation with respect to the illustrated specific embodiments or examples is intended or should be inferred. The disclosure is intended to cover by the appended claims all such modifications as fall within the scope of the claims.

We claim:

1. A method for clarifying wastewater, the method comprising the following steps:
providing wastewater;
adding a substance comprising a porous particulate material to the wastewater.

2. The method of claim 1, wherein the porous particulate material is perlite.

3. The method of claim 2, wherein a coagulant is additionally added to the wastewater.

4. The method of claim 1, wherein the substance is additionally comprised of a coagulant.

5. The method of claim 1, wherein a coagulant is added to the wastewater after the addition of the substance.

6. The method of claim 1, wherein the substance consists essentially of perlite.

7. The method of claim 6, wherein the perlite comprises expanded perlite.

8. The method of claim 1, wherein the substance consists of perlite.

9. The method of claim 8, wherein the perlite comprises expanded perlite.

10. The method of claim 2, wherein the perlite comprises expanded perlite.

11. The method of claim 1, wherein the porous particulate material is coated with an oleophilic/hydrophobic layer.

12. The method of claim 3, wherein a flocculant is additionally added to the wastewater,

13. The method of claim 4, wherein a flocculant is additionally added to the wastewater subsequent to the adding of the substance.
